(19) United States
(12) Patent Application Publication
(10) Pub. No.: US 2008/0231163 A1
(43) Pub. Date: Sep. 25, 2008

(54) PLASMA DISPLAY PANEL AND METHOD FOR MANUFACTURING THE SAME

(76) Inventor: Sung Chun CHOI, Anyang-si (KR)

Correspondence Address: KED & ASSOCIATES, LLP, P.O. Box 221200, Chantilly, VA, 20153-1200, US

(21) Appl. No.: 12/051,208

(22) Filed: Mar. 19, 2008

(30) Foreign Application Priority Data
Mar. 20, 2007 (KR) 10-2007-0027312

(51) Int. Cl. H01J 1/62; H01J 9/00

(52) U.S. Cl. 313/487; 313/489; 445/22

(57) ABSTRACT

A plasma display panel and a method for manufacturing the same are disclosed. The plasma display panel includes a first substrate comprising first electrodes, a second substrate arranged to face the first substrate, the second substrate comprising second electrodes, barrier ribs formed between the first and second substrates, to define discharge cells, and a phosphor layer formed in each of the discharge cells. The phosphor layer includes a phosphor and a dielectric having a secondary electron emission coefficient higher than the phosphor.

This application claims the benefit of Korean Patent Application No. 10-2007-0027312, filed on Mar. 20, 2007, which is hereby incorporated by reference as if fully set forth herein.

### BACKGROUND OF THE INVENTION

1. Field of the Invention

The present invention relates to a plasma display panel and a method for manufacturing the same.

2. Discussion of the Related Art

In accordance with the advent of an age of multimedia, development of a display device capable of more finely rendering colors more approximate to natural colors while having a larger size is being required.

However, the current cathode ray tubes (CRTs) have a limitation in realizing a large screen of 40 inches or more. For this reason, liquid crystal displays (LCDs), plasma display panels (PDPs), and projection televisions (TVs) are being rapidly developed so that the applications thereof can be extended to a high-quality image field.

PDPs are known as an electronic appliance to display an image, using plasma discharge. In such a PDP, a certain voltage is applied between electrodes in a discharge space defined in the PDP, to generate plasma discharge in the discharge space. A phosphor layer having a certain pattern is excited by vacuum ultraviolet rays (VUVs) generated during the plasma discharge, to produce an image.

Phosphors in the PDP have a very important function to emit visible rays of red (R), green (G), or blue (B) as they are excited and transited by ultraviolet rays generated during plasma discharge.

In a driving period of the PDP, in which red, green, and blue phosphors function as cathodes, however, the phosphors exhibit different secondary electron emission characteristics because the components thereof are different. For this reason, the discharge initiation voltages of the red, green, and blue discharge cells are different.

Due to such different discharge initiation voltages, erroneous discharge may occur during the driving operation of the PDP. Furthermore, a reduction in voltage margin may occur. As a result, a degradation in the performance of the PDP may occur.

### SUMMARY OF THE INVENTION

Accordingly, the present invention is directed to a plasma display panel and a method for manufacturing the same that substantially obviate one or more problems due to limitations and disadvantages of the related art.

An object of the present invention is to provide a plasma display panel capable of minimizing the discharge initiation voltage difference among red, green, and blue discharge cells, thereby achieving an accurate driving operation and an increased voltage margin.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises: a first substrate comprising first electrodes; a second substrate arranged to face the first substrate, the second substrate comprising second electrodes; barrier ribs formed between the first and second substrates, to define discharge cells; and a phosphor layer formed in each of the discharge cells, wherein the phosphor layer comprises a phosphor and a dielectric having a secondary electron emission coefficient higher than the phosphor.

The dielectric may be coated on surfaces of particles of the phosphor. The phosphor may have an average particle diameter of 0.1 to 5 μm, and the coating thickness of the dielectric on each particle surface of the phosphor may be 1 to 10 nm.

The dielectric may be mixed with the phosphor in an amount of 0.1 to 50 wt % based on an amount of the phosphor. The average particle diameter of the dielectric may be 0.01 to 3 μm.

The dielectric may comprise at least one of oxides of Ti, Mg, La, and F, or a mixture thereof. Preferably, the dielectric comprises at least one of TiO₂, MgF, and LaₓO_{y}.

In another aspect of the present invention, a method for manufacturing a plasma display panel comprises: preparing a first substrate having first electrodes and a second substrate having second electrodes; forming barrier ribs on the second substrate, to define a plurality of discharge cells as discharge spaces; forming phosphor layers in all or a part of the discharge cells, using a mixture of a phosphor and a dielectric having a secondary electron emission coefficient higher than the phosphor; and assembling the first and second substrates.

The step of forming the phosphor layers may comprise: coating the dielectric on particles of the phosphor; mixing a vehicle with the phosphor particles coated with the dielectric, thereby preparing a phosphor paste; coating the phosphor paste on the discharge cells, thereby forming the phosphor layers; and drying and curing the phosphor layers.

Alternatively, the step of forming the phosphor layers may comprise: mixing the dielectric with particles of the phosphor; mixing a vehicle with the phosphor particles mixed with the dielectric, thereby preparing a phosphor paste; coating the phosphor paste on the discharge cells, thereby forming the phosphor layers; and drying and curing the phosphor layers.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a plasma display panel (PDP) according to the present invention;

FIG. 2 is a sectional view of a phosphor layer coated with a dielectric;

FIG. 3 is a sectional view of a phosphor layer mixed with a dielectric;

FIG. 4 is a graph depicting a discharge initiation voltage in the PDP according to the present invention;

FIG. 5 is a graph depicting a variation in the emission amount of light depending on a variation in the mixture ratio of the dielectric to the phosphor;

FIG. 6 is a view illustrating a driver circuit and connectors in the PDP according to the present invention;

FIG. 7 is a view illustrating a wiring structure of a tape carrier package (TCP);

FIG. 8 is a view schematically illustrating an embodiment different from that of FIG. 6;

FIGS. 9A to 9K are views illustrating an exemplary embodiment of a method for manufacturing the PDP according to the present invention;

FIG. 10A is a view illustrating the process for assembling front and back substrates of the PDP; and

FIG. 10B is a cross-sectional view taken along the line A-A′ of FIG. 10A.

### DETAILED DESCRIPTION OF THE INVENTION

Reference will now be made in detail to the preferred embodiments of the present invention, examples of which are illustrated in the accompanying drawings.

Hereinafter, configurations and operations according to the present invention will be described in detail in conjunction with embodiments of a plasma display panel (PDP) according to the present invention. Although the configurations and functions of the present invention are illustrated in the accompanying drawings, in conjunction with at least one embodiment, and described with reference to the accompanying drawings and the embodiment, the technical idea of the present invention and the important configurations and functions thereof are not limited thereto.

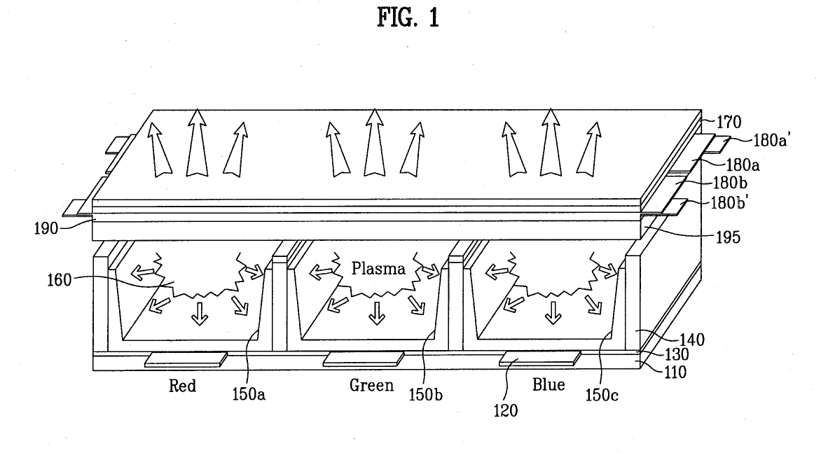

FIG. 1 is a sectional view partially illustrating a PDP according to an exemplary embodiment of the present invention. As shown in FIG. 1, the PDP includes a front substrate 170, and sustain electrode pairs formed on the front substrate 170 while extending in one direction. Each sustain electrode pair includes a transparent electrode 180a or 180b typically made of indium tin oxide (ITO), and a bus electrode 180a′ or 180b′.

The PDP also includes a dielectric layer 190 and a passivation film 195 sequentially formed, in this order, over the overall surface of the front substrate 170, to cover the sustain electrode pairs.

The front substrate 170 is prepared by machining a glass for a display substrate, using milling, cleaning, etc.

The transparent electrodes 180a and 180b are formed in accordance with a photo-etching method using a sputtering process or a lift-off method using a chemical vapor deposition (CVD) process.

The bus electrodes 180a′ and 180b′ are made of a material comprising a general-purpose conductive metal and a rare metal.

The general-purpose conductive metal may include aluminum (Al), copper (Cu), nickel (Ni), chromium (Cr), and molybdenum (Mo). On the other hand, the rare metal may include silver (Ag), gold (Au), platinum (Pt), and iridium (Ir).

When the general-purpose conductive metal and rare metal are mixed to prepare the material of the bus electrodes, the general-purpose conductive metal forms a core such that the rare metal encloses the core.

As described above, the dielectric layer 190 is formed over the front substrate 170 formed with the transparent electrodes and bus electrodes.

The material of the dielectric layer 190 contains a transparent glass having a low melting point. The detailed composition of the material of the dielectric layer 190 will be described later.

Over the dielectric layer 190, which is an upper dielectric layer, the passivation film 195 is formed, using magnesium oxide, etc. The passivation film 195 functions to protect the upper dielectric layer 190 from an impact of positive (+) ions during an electrical discharge, while functioning to increase the emission of secondary electrons.

The PDP further includes a back substrate 110. Address electrodes 120 are formed on one surface of the back substrate 110 such that they extend in a direction perpendicular to the extension direction of the sustain electrode pairs. A white dielectric layer 130 is also formed over the overall surface of the back substrate 110, to cover the address electrodes 120.

The address electrodes 120 may be made of a material comprising general-purpose conductive metal and rare metal. The general-purpose conductive metal may include aluminum (Al), copper (Cu), nickel (Ni), chromium (Cr), and molybdenum (Mo). On the other hand, the rare metal may include silver (Ag), gold (Au), platinum (Pt), and iridium (Ir).

The formation of the white dielectric layer 130 may be achieved by coating a material of the white dielectric layer 130, using a printing method or a film laminating method, and then curing the coated material. Barrier ribs 140 are formed on the white dielectric layer 130 such that each barrier rib 140 is arranged between the adjacent address electrodes 120.

The barrier ribs 140 may be of a stripe type, a well type, or a delta type.

The barrier ribs 140 are made of a material comprising a parent glass and a porous filler. The parent glass may include a lead-based parent glass or and a lead-free parent glass. The lead-based parent glass may include ZnO, PbO, or B₂O₃. On the other hand, the lead-free parent glass may include ZnO, B₂O₃, BaO, SrO, or CaO.

The filler may include an oxide such as SiO₂ or Al₂O₃. Although not shown, a black top may be formed on each barrier rib 140.

Red (R), green (G), and blue (B) phosphor layers 150a, 150b, and 150c are formed on the white dielectric layer 130 such that each phosphor layer 250 is arranged between the adjacent barrier ribs 240.

In order to minimize the discharge initiation voltage difference among R, G, and B discharge cells, each of the R, G, and B phosphor layers 150a, 150b, and 150c is made of a material comprising a phosphor and a dielectric having a secondary electron emission coefficient higher than that of the phosphor.

There may be two methods usable to form the phosphor layers 150a, 150b, and 150c in accordance with the present invention.

The first method is a method in which a dielectric is coated on the surface of phosphor powder. The second method is a method in which a dielectric is mixed with phosphor powder.

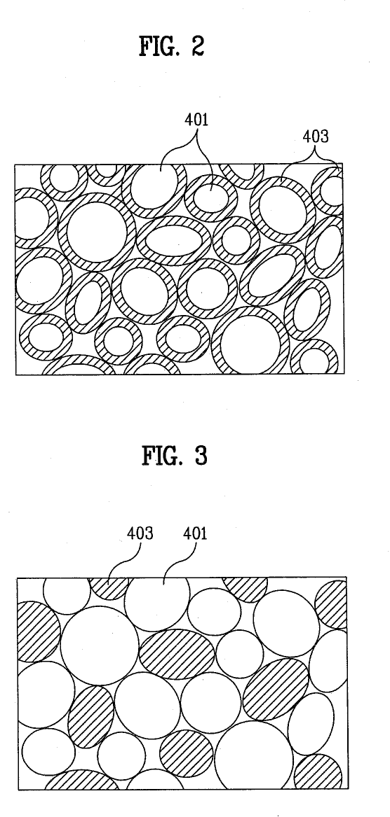

FIG. 2 is a sectional view illustrating phosphor layers in which a dielectric is coated on the surface of phosphor powder. FIG. 3 is a sectional view illustrating phosphor layers in which a dielectric is mixed with phosphor powder.

The first method to form the phosphor layers is as follows.

As shown in FIG. 2, a dielectric 403 is first coated on the surface of phosphor powder 401. Thereafter, a vehicle is mixed with the phosphor powder 401 coated with the dielectric 403, to prepare a phosphor paste.

Preferably, the average particle diameter of the phosphor powder 401 coated with the dielectric 403 is about 0.1 to 5 μm. Preferably, the coating thickness of the dielectric 403 is about 1 to 100 nm.

It is also preferred that the dielectric 403 be coated in an amount of about 0.1 to 50 wt %, based on the total amount of the phosphor powder.

When the coating thickness and amount of the dielectric 403 is determined as described above, it is possible to minimize the discharge initiation voltage difference among the discharge cells.

That is, when the dielectric 403 is coated under the above-described conditions, the discharge voltage difference among the discharge cells may correspond to about 1 to 5% of a minimum discharge initiation voltage. Also, in this case, the visible ray reflectance of each discharge cell may be about 5 to 20%.

The dielectric 403 may comprise at least one of oxides of Ti, Mg, La, and F, or a mixture thereof. More preferably, the dielectric 403 may comprise at least one of TiO₂, MgF, and LaₓO_{y}.

Meanwhile, for the phosphor powder 401, any of a blue phosphor, a green phosphor, and a red phosphor may be used.

For the red phosphor, Y(V,P)O₄:Eu or (Y,Gd)BO₃:Eu may be used. For the green phosphor, a material selected from the group consisting of Zn₂SiO₄:Mn, (Zn,A)₂SiO₄:Mn (“A” is an alkali metal), and a mixture thereof may be used.

Also, a mixture of the green phosphor with at least one phosphor selected from the group consisting of BaAl₁₂O₁₉:Mn, (Ba, Sr, Mg)OₐAl₂O₃:Mn (“a” is a natural number of 1 to 23), MgAlₓO_{y}:Mn (x=1 to 10, and y=1 to 30), LaMgAlₓO_{y}:Tb, Mn (x=1 to 14, and y=8 to 47), and ReBO₃:Tb (“Re” is at least one rare earth element selected from the group consisting of Sc, Y, La, Ce, and Gd) may be used.

For the blue phosphor, BaMgAl₁₀O₁₇:Eu, CaMgSi₂O₆:Eu, CaWO₄:Pb, Y₂SiO₅:Eu, or a mixture thereof may be used.

In accordance with the present invention, for the vehicle, a mixture of about 5 to 80 wt % of an organic binder and about 10 to 95 wt % of a solvent may be used.

In this case, the organic binder may comprise an organic polymer, for example, a cellulose-based polymer, an acryl-based polymer, or a vinyl-based polymer.

The cellulose-based polymer usable in the present invention may include methyl cellulose, ethyl cellulose, or nitrocellulose. The acryl-based polymer may include polymethylmethacrylate, polymethylacrylate, polyethylacrylate, polyethylmethacrylate, poly-normal-propylacrylate, poly-normal-propylmethacrylate, poly-iso-propylacrylate, poly-iso-propylmethacrylate, poly-normal-butylacrylate, poly-normal-butylmethacrylate, poly-cyclo-hexylacrylate, poly-cyclo-hexylmethacrylate, polylaurylacrylate, polylaurylmethacrylate, polystearylacrylate, or polystearylmethacrylate. A copolymer of monomers of at least two of the polymers may also be used.

The vinyl-based polymer may include polyethylene, polypropylene, polystyrene, polyvinyl alcohol, polybutylacetate, and polyvinylpyrrolidone.

These polymers may be used alone, or may be used in combination, if necessary.

For the solvent, any solvent may be used, as long as it can dissolve the organic polymer, namely, the cellulose-based polymer, acryl-based polymer, or vinyl-based polymer.

The solvent may be an organic solvent such as benzene, alcohol, chloroform, ester, cyclohexanon, N,N-dimethylacetamaid, or acetonitrile, or a watersoluble solvent such as water, an aqueous solution of potassium sulphate, or an aqueous solution of magnesium sulphate. The solvents may be selectively used alone or in combination of two or more.

The paste of the dielectric-coated phosphors may contain additives such as an acryl-based dispersing agent for an enhancement in flowability, a silicon-based antifoaming agent, lubricating agent, an antioxidant, and a plasticizer such as dioctylphthalate.

Preferably, the content of the additives is about 0.1 to 5 wt % based on the total weight of the phosphor composition.

When the content of the additives is beyond the range of 0.1 to 5 wt %, a degradation in printability may occur.

The formation of the phosphor layers may be achieved by coating the phosphor paste prepared in the above-described manner, in each discharge cell.

The coating of the phosphor layers may be achieved, selectively using a screen printing method, a doctor blade method, a dip method, a reverse roll method, a direct roll method, a gravure method, an extrusion method, a brush method, etc. The screen printing method is preferable.

Thereafter, the phosphor layers are dried and cured, to remove residual organic substances from the phosphor layers.

The drying process for the phosphor layers may be carried out at a temperature of about 50 to 250° C. for about 5 to 90 minutes. The curing process may be carried out in a vacuum or in a reducing atmosphere containing inert gas at a temperature of about 300 to 600° C. for about 30 to 60 minutes.

More preferably, the curing process is carried out at a low temperature of about 400 to 550° C. for about 30 to 60 minutes.

When the curing temperature is excessively low, or the curing time is excessively short, it is difficult to remove residual organic substances from the phosphor layers. On the other hand, when the curing temperature is excessively high, or the curing time is excessively long, the phosphor layers may be degraded.

Meanwhile, the second method to form the phosphor layers is as follows.

As shown in FIG. 3, a dielectric 403 is first mixed with phosphor powder 401. Thereafter, a vehicle is mixed with the mixture of the phosphor powder 401 with the dielectric 403, to prepare a phosphor paste.

Preferably, the dielectric 403 is mixed in an amount of about 0.1 to 50 wt %, based on the total amount of the phosphor powder. Preferably, the average particle diameter of the dielectric 403 is about 0.01 to 3 μm. Preferably, the average particle diameter of the phosphor powder 401 is about 0.1 to 5 μm.

When the phosphor powder 401 and dielectric 403 are mixed under the above-described conditions, the discharge voltage difference among the discharge cells may correspond to about 1 to 5% of a minimum discharge initiation voltage. Also, in this case, the visible ray reflectance of each discharge cell may be about 5 to 20%.

The dielectric 403 may comprise at least one of oxides of Ti, Mg, La, and F, or a mixture thereof. More preferably, the dielectric 403 may comprise at least one of TiO₂, MgF, and LaₓO_{y}.

Meanwhile, for the phosphor powder 401, any of a blue phosphor, a green phosphor, and a red phosphor may be used.

In accordance with the present invention, for the vehicle, a mixture of about 5 to 80 wt % of an organic binder and about 10 to 95 wt % of a solvent may be used.

In this case, the organic binder may comprise an organic polymer, for example, a cellulose-based polymer, an acryl-based polymer, or a vinyl-based polymer.

The formation of the phosphor layers may be achieved by coating the phosphor paste prepared in the above-described manner, in each discharge cell.

The coating of the phosphor layers may be achieved, selectively using a screen printing method, a doctor blade method, a dip method, a reverse roll method, a direct roll method, a gravure method, an extrusion method, a brush method, etc. The screen printing method is preferable.

Thereafter, the phosphor layers are dried and cured, to remove residual organic substances from the phosphor layers.

The drying process for the phosphor layers may be carried out at a temperature of about 50 to 250° C. for about 5 to 90 minutes. The curing process may be carried out in a vacuum or in a reducing atmosphere containing inert gas at a temperature of about 300 to 600° C. for about 30 to 60 minutes.

More preferably, the curing process is carried out at a low temperature of about 400 to 550° C. for about 30 to 60 minutes.

After the formation of the phosphor layers 150a, 150b, and 150c in the above-described manner, the front substrate 170 and back substrate 110 are assembled to each other such that the barrier ribs 140 are interposed between the front substrate 170 and the back substrate 110. The assembly of the panels is achieved by a sealant provided along the peripheries of the front and back substrates 170 and 110.

Upper and lower panels, which are constituted by the front and back substrates 170 and 110, respectively, are connected to a driver.

Hereinafter, the reason why a mixture of a phosphor and a dielectric is used for each of the phosphor layers 150a, 150b, and 150c, as described above, will be described.

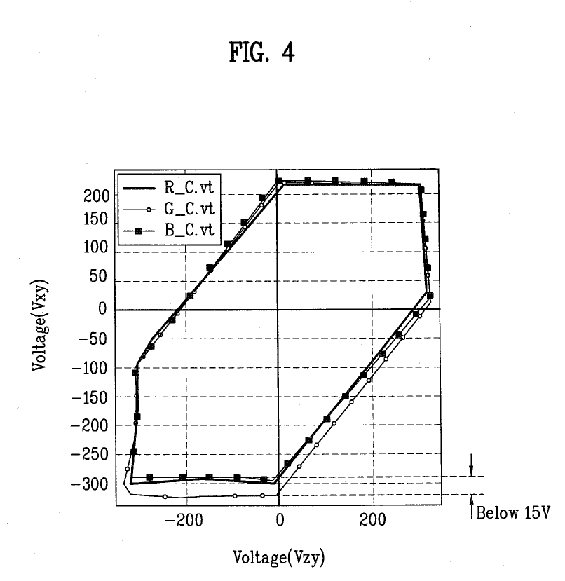

A discharge initiation voltage is set in the form of a closed voltage (Vt) curve as shown in FIG. 4, in accordance with a voltage difference among a scan electrode y, sustaining electrode z, and an address electrode x.

In FIG. 4, the horizontal axis represents the voltage difference Vzy between the sustaining electrode z and the scan electrode y, and the vertical axis represents the voltage difference Vxy between the address electrode x and the scan electrode y.

In order to enable the PDP to emit light, a voltage is applied between electrodes arranged at opposite sides of inert gas, such as Xe or Ne, in each discharge cell.

In accordance with the application of the voltage, an electric field is established between the electrodes. When there are electrons between the electrodes, the electrons are accelerated as they receive energy. The accelerated electrons strike neutral atoms, thereby transferring energy to the neutral atoms.

When the energy transferred to the neutral atoms is higher than ionization energy, the neutral atoms are separated into electrons having negative charge and ions having positive charge (Xe⁺ and Ne⁺).

When the separated ions strike the passivation film or phosphor layers, another electron is emitted. This electron is called a “secondary electron”.

As is well known, the higher the secondary electron emission coefficient, the higher the secondary electron emission rate. At a higher secondary electron emission coefficient, namely, a higher secondary electron emission rate, the discharge initiation voltage of the PDP is lowered.

When the voltage difference Vzy between the sustaining electrode z and the scan electrode y in the upper panel is positive at a constant address voltage, positive ions strike the passivation film in the vicinity of the scan electrode y, which is negative, as compared to the sustaining electrode z. On the other hand, when the voltage difference Vzy is negative, positive ions strike the passivation film in the vicinity of the sustaining electrode z, which is negative, as compared to the scan electrode y. In accordance with the striking of positive ions, secondary electrons are emitted.

Since each discharge cell has a symmetrical structure, irrespective of the kind of the discharge cell, namely, the R, G, or B discharge cell, there is no discharge initiation voltage difference among the discharge cells upon the discharge caused by the voltage difference between the sustain electrode and the scan electrode in each discharge cell.

However, when the voltage difference Vxy between the address electrode x and the scan electrode y is positive, positive ions strike the passivation film in the vicinity of the scan electrode y, which is negative, as compared to the address electrode x. In accordance with the striking of positive ions, secondary electrons are emitted.

In this case, there is no or little discharge initiation voltage difference caused by different characteristics of different phosphors, as depicted in the graphs of FIG. 4. because the passivation film is made of a material having a high secondary electron emission coefficient, namely, MgO, irrespective of the kind of the discharge cell, namely, the R, G, or B discharge cell.

However, when the voltage difference Vxy is negative, positive ions strike the phosphor layer, because the address electrode x, which is negative, as compared to the scan electrode y, namely, functions as a cathode. In accordance with the striking of positive ions, secondary electrons are emitted.

Different phosphors, which emit lights of different colors, for example, R, G, and B, have different secondary electron emission coefficients, respectively.

For this reason, in this case, there is a discharge initiation voltage difference among the discharge cells, as shown in FIG. 4.

In order to enable the driving of all discharge cells when there is a discharge initiation voltage difference among the discharge cells, it is necessary to apply a voltage equal to or higher than the discharge initiation voltage of the discharge cell, which requires a maximum discharge initiation voltage, as compared to other discharge cells.

Here, it is noted that the level of the discharge initiation voltage is determined, only based on the voltage difference, irrespective of the polarity.

However, the application of a voltage equal to or higher than the maximum discharge initiation voltage is inefficient because this voltage is unnecessarily high for the discharge cells requiring a discharge initiation voltage lower than the maximum discharge initiation voltage. Furthermore, the voltage margin for the driving of the panel is narrowed, so that a degradation in the performance of the panel may occur.

In accordance with the present invention, however, it is possible to control the discharge initiation voltage of each discharge cell because the phosphor layers are completely or partially made of a mixture of a phosphor and a dielectric having a secondary electron emission coefficient higher than that of the phosphor. That is, the discharge initiation voltage of each discharge cell can be controlled in accordance with the mixture ratio of the dielectric.

Referring to FIG. 4, the discharge characteristics of the PDP according to the present invention can be seen.

When the address electrode of each discharge cell functions as a cathode (Vxy<0), the R, G, and B discharge cells exhibit different discharge initiation voltages such that an increase in discharge initiation voltage occurs in the order of B, R, and G discharge cells.

In this case, it is possible to reduce the difference between the minimum discharge initiation voltage and the maximum discharge initiation voltage within a desired range by not adding dielectric to the phosphor layer of the B discharge cell exhibiting the minimum discharge initiation voltage or adding a smallest amount of dielectric to the phosphor layer of the B discharge cell, while adding a largest amount of dielectric to the phosphor layer of the G discharge cell exhibiting the maximum discharge initiation voltage.

Preferably, the discharge initiation voltage difference among the discharge cells corresponds to 5% or less of the minimum discharge initiation voltage.

For example, in accordance with the present invention, the content of the dielectric is controlled such that the difference between the minimum discharge voltage and the maximum discharge voltage is 15V, because the minimum discharge voltage of the B discharge cell is 300V.

Thus, the present invention provides effects capable of reducing the discharge initiation voltage difference among the discharge cells emitting lights of different colors, and thus achieving a reduction in discharge initiation voltage as a whole, by adding a dielectric having a secondary electron emission coefficient higher than that of a phosphor to the phosphor.

However, when the dielectric is added to the phosphor, the efficiency of transferring energy to the phosphor is reduced, as compared to the case in which the phosphor is used alone. In this case, the emission amount of light is also reduced because the emitted light is shielded.

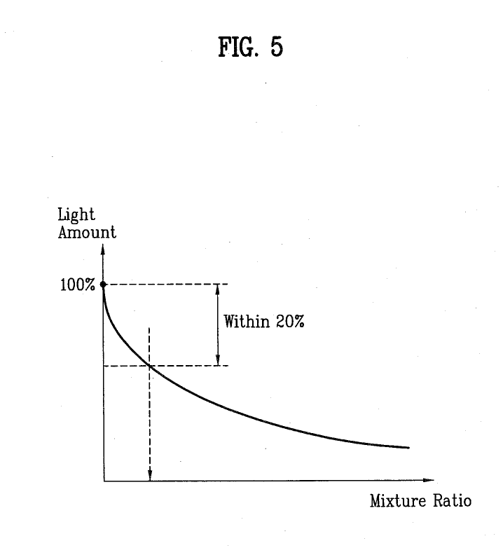

FIG. 5 is a graph depicting a variation in the emission amount of light depending on an increase in the mixture ratio of the dielectric to the phosphor.

Referring to FIG. 5, it can be seen that the higher the mixture ratio of the dielectric, the lower the emission amount of light.

Accordingly, it is preferred that the addition amount of the dielectric be determined such that the reduction in the emission amount of light caused by the addition of the dielectric is 20% or less.

As described above, two methods may be mainly used for the addition of the dielectric.

As shown in FIG. 2, the first method is to coat the dielectric 403 on the particle surface of the phosphor 401.

The coated dielectric 403 should have a secondary electron emission coefficient higher than that of the phosphor 401. For the dielectric 403, fine particles having a diameter of several hundred Å or less smaller than that of the phosphor 401 may be used.

Generally, ions excited in a discharge space, for example, Xe⁺ or Ne⁺, have a resonance level substantially corresponding to the ultraviolet ray wavelength of 147 nm.

In accordance with the quantum theory of light (E=hv=hc/λ), the energy gap of the resonance level has energy of about 8.44 eV.

Accordingly, when the band gap of the dielectric is about 8.44 eV or more, the energy of the ions cannot be absorbed in the dielectric, so that it is transferred mainly to the phosphor. However, when the band gap of the dielectric is less than 8.44 eV, the energy of the ions is absorbed in the dielectric at the wavelength of 147 nm, so that an abrupt decrease in optical power occurs.

Therefore, it is preferred that a material having an energy band gap of about 8.44 eV or more be used for the dielectric.

For such a dielectric, MgF or LaₓO_{y} may be used. In LaₓO_{y}, “x” and “y” are constants.

Preferably, the addition amount of the dielectric is determined within a range in which the maximum emission amount of light is reduced by 20% or less. It is also preferred that the addition amount of the dielectric be controlled such that the discharge initiation voltage difference among the R, G, and B discharge cells corresponds to 5% or less of the minimum discharge voltage.

Meanwhile, the second method is to mix the particles of the phosphor 401 with the particles of the dielectric 403, as shown in FIG. 3.

Similarly to the first method, the mixed dielectric 403 should have a secondary electron emission coefficient higher than that of the phosphor 401, in the second method. It is also preferred that the particles of the dielectric 403 have an average diameter of 3 μm or less.

Similarly to the first method, it is preferred that a material having an energy band gap of about 8.44 eV or more be used for the dielectric, in the second method, in order to enable the energy of positive ions to be transferred to the phosphor without being absorbed in the dielectric.

For the dielectric to be mixed with the phosphor, TiO₂ or the like may be used.

Preferably, the addition amount of the dielectric is determined within a range in which the maximum emission amount of light is reduced by 20% or less. It is also preferred that the addition amount of the dielectric be controlled such that the discharge initiation voltage difference among the R, G, and B discharge cells corresponds to 5% or less of the minimum discharge voltage.

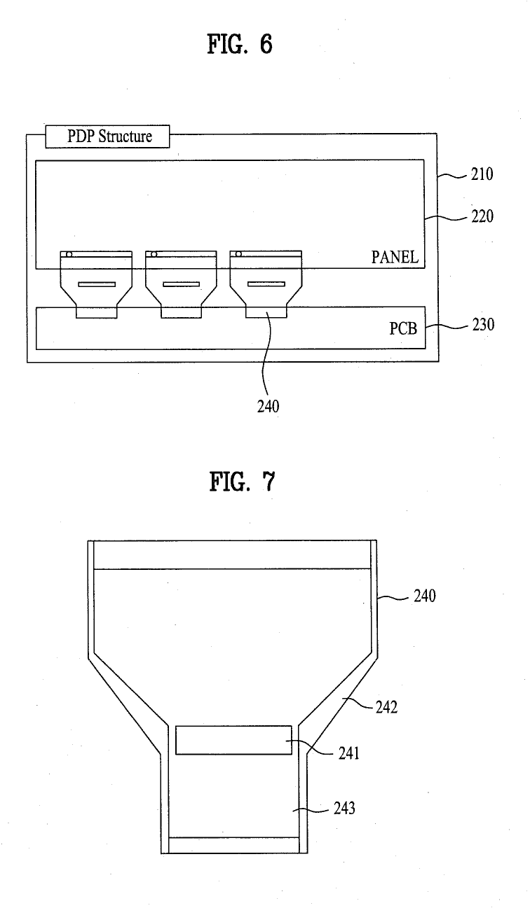

FIG. 6 is a view illustrating a driver circuit and connectors in the PDP according to the present invention.

As shown in FIG. 6, the PDP includes a panel 220, a driver board 230 to supply a drive voltage to the panel 220, and tape carrier packages (TCPs) 240 to connect the electrodes of cells included in the panel 220 to the driver board 230. Each TCP comprises a flexible board. The driver board 230 may comprise a printed circuit board (PCB), as shown in FIG. 6.

As described above, the panel 220 includes a front substrate, a back substrate, and barrier ribs.

The electrical and physical connection between the panel 220 and each TCP 240 and the electrical and physical connections between each TCP 240 and the driver board 230 are achieved using anisotropic conductive films (ACFs). Each ACF is a conductive resin film formed using a nickel ball coated with gold (Au).

FIG. 7 is a view illustrating a wiring structure of one TCP.

As shown in FIG. 7, the TCP 240, which functions to connect the panel 220 and the driver board 230, includes a flexible substrate 242, wirings 243 densely arranged on the flexible substrate 242, and a driver chip 241 connected to the wirings, to receive electric power from the driver board 230 and to supply the received electric power to a selected one of the associated electrodes of the panel 220.

The driver chip 241 has a configuration to receive a small number of voltages and a small number of drive control signals and to alternately output a large number of high-power signals. For this reason, the number of the wirings 243 connected to the driver board 230 is large, whereas the number of the wirings 243 connected to the panel 220 is small.

Although the wirings 243 are divided with respect to the driver chip 241 in the illustrated case, they may not be divided with respect to the driver chip 241 because the wiring connection for the driver chip 241 may be achieved, using a space provided at the driver board 230.

FIG. 8 is a view schematically illustrating an embodiment different from that of FIG. 6.

In this embodiment, the panel 220 is connected with the driver board 230 via a flexible printed circuit (FPC) 250.

The FPC 250 comprises a film made of polyimide, and formed with a certain pattern. In this embodiment, the FPC 250 and panel 220 are connected via an ACF.

As in the previous embodiment, the driver board 230 comprises a PCB.

The driver circuit includes a data driver, a scan driver, and a sustaining driver. The data driver is connected to the address electrodes, to apply a data pulse to the address electrodes. The scan driver is connected to the scan electrodes, to supply a ramp-up signal, a ramp-down signal, a scan pulse, and a sustaining pulse to the scan electrodes.

The sustaining driver applies a sustaining pulse and a DC voltage to a common sustain electrode.

The PDP operates in a driving period divided into a reset period, an address period, and a sustaining period.

In the reset period, the ramp-up signal is applied to the scan electrodes in a simultaneous manner. In the address period, a negative scan pulse is applied to the scan electrodes in a sequential manner. In synchronism with the scan pulse, a positive data pulse is applied to the address electrodes.

In the sustaining period, a sustaining pulse is applied to the scan electrodes and sustaining electrodes in an alternating manner.

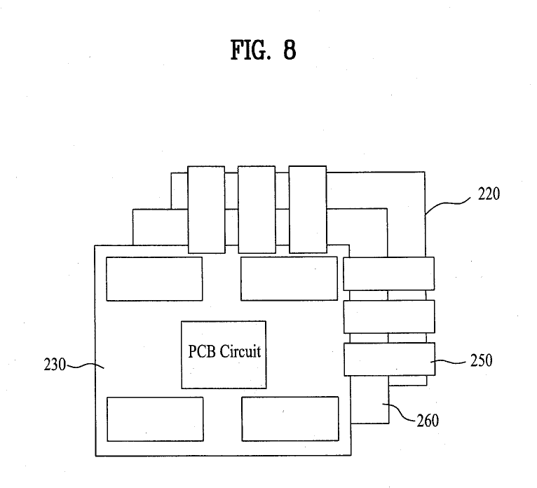

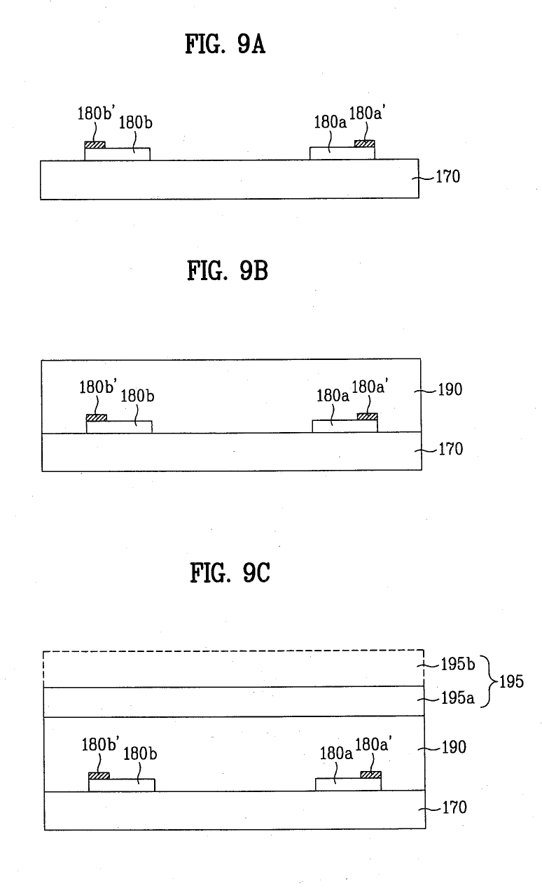

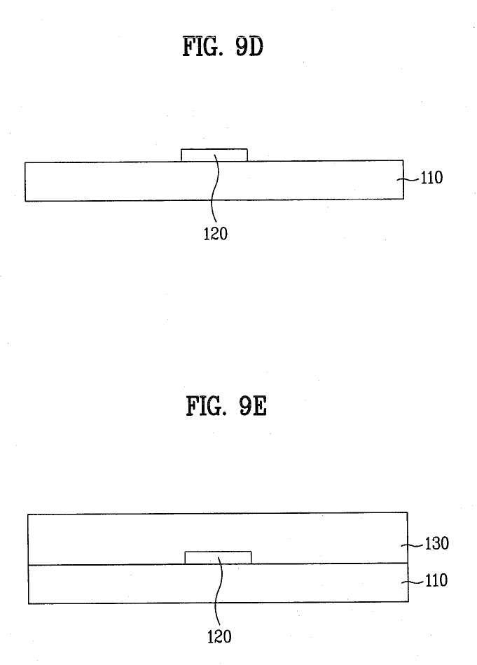

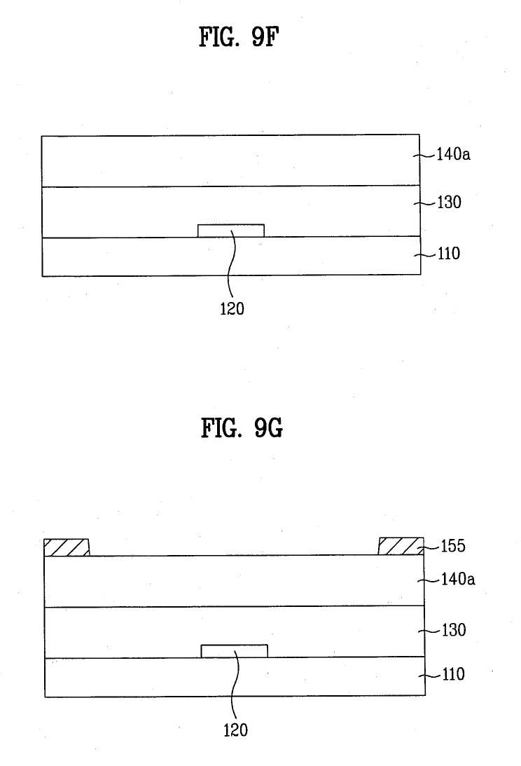

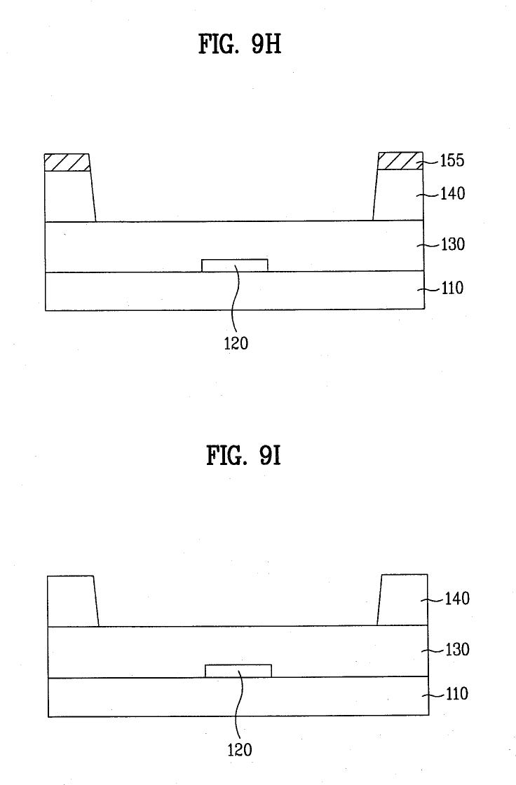

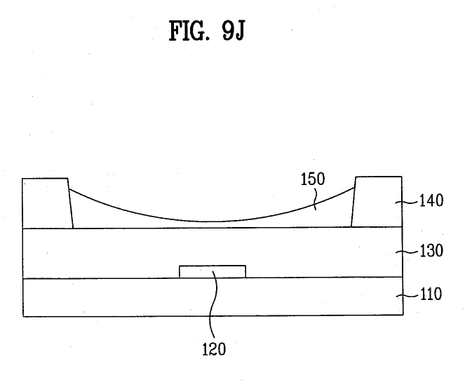

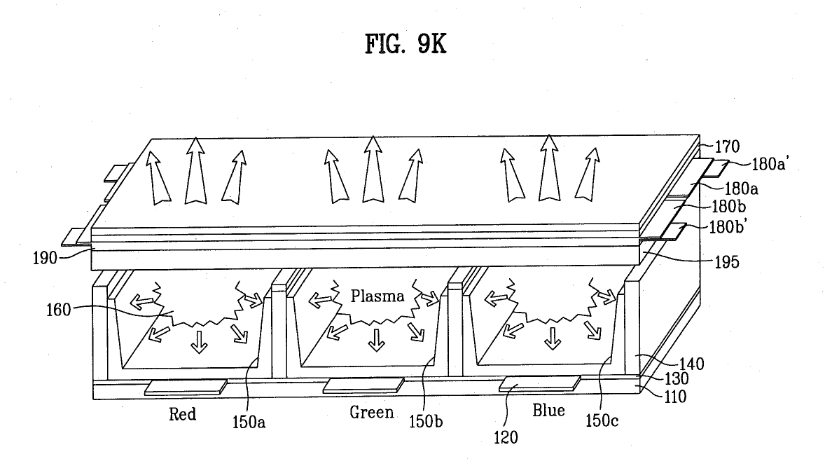

FIGS. 9A to 9K are views illustrating an exemplary embodiment of a method for manufacturing the PDP according to the present invention.

Hereinafter, the PDP manufacturing method according to the present invention will be described with reference to FIGS. 9A to 9K.

First, transparent electrodes 180a and 180b and bus electrodes 180a′ and 180b′ are formed on a front substrate 170, as shown in FIG. 9A.

The front substrate 170 is prepared by milling and cleaning a glass or a sodalime glass for a display substrate.

The transparent electrodes 180a and 180b are made of ITO or SnO2, and are formed in accordance with a photoetching method using sputtering or a lift-off method using CVD.

The bus electrodes 180a′ and 180b′ are made of a material containing a general-purpose conductive metal and a rare metal.

The bus electrode material may be prepared in the form of a paste by mixing the general-purpose conductive metal and rare metal. Alternatively, the bus electrode material may be prepared to have a structure including a core of general-purpose conductive metal and a rare metal layer coated on the surface of the core.

Thereafter, a dielectric 190 is formed over the surface of the front substrate 170 formed with the transparent electrodes 180a and 180b and bus electrodes 180a′ and 180b′, as shown in FIG. 9B.

The dielectric 190 is formed by depositing a material containing a glass having a low melting point, etc. in accordance with a screen printing method or a coating method, or by laminating a green sheet.

The bus electrode material and dielectric 190 may be cured. In this case, the curing of the bus electrode material and dielectric 190 can be achieved in separate processes, respectively, or may be achieved in a single process, to simplify the curing process.

Preferably, the curing temperature is about 500 to 600° C. Where the bus electrodes and dielectric are simultaneously cured, it is possible to reduce the oxidation amount of the bus electrode material because the dielectric shields the bus electrodes from oxygen.

Subsequently, a passivation film 195 is deposited over the dielectric 190.

The passivation film 195 is made of magnesium oxide. The passivation film material may contain silicon, etc. as a dopant. The deposition of the passivation film 195 may be achieved using a CVD method, an e-beam method, an ion plating method, a sol-gel method, or a sputtering method.

Thereafter, address electrodes 120 are formed on a back substrate 110, as shown in FIG. 9D.

The back substrate 110 is prepared by machining a glass or a sodalime glass for a display substrate, using milling or cleaning. The address electrodes 120 may be made of silver (Ag), and may be formed in accordance with a screen printing method, a photosensitive paste method, or a photoetching method involving pre-sputtering.

The address electrodes 120 may be formed using a material comprising a general-purpose conductive metal and a rare metal. The detailed process for the formation of the address electrodes 120 is identical to that of the bus electrodes.

Subsequently, a dielectric 130 is formed over the surface of the back substrate 110 formed with the address electrodes 120, as shown in FIG. 9E.

The dielectric 130 is formed by depositing a material containing a glass having a low melting point and a filler such as TiO₂ in accordance with a screen printing method or a coating method, or by laminating a green sheet. Preferably, the dielectric 130 of the back substrate 110 exhibits white, in order to achieve an increase in the brightness of the PDP.

In order to simplify the process, the dielectric 130 and address electrodes 120 may be cured in a single process.

Thereafter, barrier ribs are formed to define individual discharge cells, as shown in FIGS. 9F to 9I.

For the formation of the barrier ribs, a barrier rib material 140a is first prepared. The preparation of the barrier rib material 140a is achieved by mixing a dispersing agent, a parent glass, and a porous filler with a solvent, and milling the resultant mixture.

The parent glass may include a lead-based parent glass or and a lead-free parent glass. The lead-based parent glass may include ZnO, PbO, or B₂O₃. On the other hand, the lead-free parent glass may include ZnO, B₂O₃, BaO, SrO, or CaO. The filler may include an oxide such as SiO₂ or Al₂O₃.

Subsequently, the barrier rib material 140a is coated over the dielectric 130 of the back substrate 110, as shown in FIG. 9F.

The coating of the barrier rib material 140a may be achieved using a spray coating method, a bar coating method, a screen printing method, or a green sheet method. Preferably, a green sheet for the barrier rib material 140a is prepared, and is then laminated.

The barrier rib material 140a is then patterned. The patterning of the barrier rib material 140a may be achieved using a sanding method, an etching method, or a photoresist method. The following description will be given in conjunction with the etching method.

First, dry film resists (DFRs) 155 are formed on the barrier rib material 140a such that the DFRs 155 are uniformly spaced apart from one another by a certain distance, as shown in FIG. 9G.

Preferably, the DFRs 155 are formed at positions where barrier ribs will be arranged, respectively.

Thereafter, the barrier rib material 140a is patterned to form barrier ribs 140, as shown in FIG. 9H.

That is, an etchant is sprayed over the DFRs 155. As a result, the barrier rib material 140a is gradually etched in regions where the DFRs 155 are not arranged. Thus, the barrier rib material 140a is patterned in the form of the barrier ribs 140.

Subsequently, the DFRs 155 are removed. The etchant is then removed in accordance with a rinsing process. A curing process is then carried out. Thus, the barrier ribs 140 are completely formed, as shown in FIG. 9I.

Here, the barrier ribs 140 may be of a stripe type, a well type, or a delta type, as described above.

Thereafter, phosphor layers 150a, 150b, and 150c are coated over the surfaces of the back-substrate-side dielectric 130 facing discharge spaces and the side surfaces of the barrier ribs 140, as shown in FIG. 9J.

The coating of the phosphor layers 150a, 150b, and 150c is carried out such that R, G, and B phosphors are sequentially coated in respective discharge cells. The coating may be achieved using a screen printing method or a photosensitive paste method.

For all or a part of the discharge cells, the material of each of the phosphor layers 150a, 150b, and 150c is prepared by mixing a phosphor with a dielectric having a secondary electron emission coefficient higher than that of the phosphor.

The preparation of the material of each phosphor layer can be achieved using two methods, as described above.

The first method is a method in which a dielectric is coated on the surface of phosphor powder. The second method is a method in which a dielectric is mixed with phosphor powder.

In either case, it is preferred that the mixture ratio of the dielectric be controlled such that the discharge initiation voltage difference among the discharge cells corresponds to 5% or less of a minimum discharge initiation voltage. It is also preferred that the addition amount of the dielectric be determined such that the reduction in the emission amount of light caused by the addition of the dielectric is 20% or less.

As the phosphor layers of the present invention contain a dielectric having a high secondary electron emission coefficient, as described above, it is possible to reduce the discharge initiation voltage difference among the discharge cells, and thus to increase the margin of the driving voltage. It is also possible to increase the secondary electron emission coefficient as a whole, and thus to reduce the discharge initiation voltage. Thus, a PDP having an enhance efficiency can be provided.

Subsequently, an upper panel including the front substrate is assembled to a lower panel including the back substrate, such that the barrier ribs are interposed between the upper and lower panels, as shown in FIG. 9K. The upper and lower panels are then sealed. The space between the upper and lower panels is then evacuated, to remove impurities from the space. Thereafter, a discharge gas 160 is injected into the space.

Now, the sealing process for the upper and lower panels will be described in detail.

The sealing process may be achieved using a screen printing method or a dispensing method.

In the screen printing method, a screen having uniformly-spaced patterns is laid on the substrate of one panel. A sealant paste is then applied to the substrate under pressure such that the sealant pate is transferred to the substrate. Thus, a sealant having a desired shape is printed on the panel. This screen printing method has advantages of simple production equipment and a high material use efficiency.

On the other hand, in the dispensing method, a sealant is formed on the substrate by directly applying a thick paste to the substrate by an air pressure, based on CAD data used in the manufacture of a screen mask. The dispensing method has advantages of saving of mask manufacturing costs and a high degree of freedom in the shape of the thick sealant.

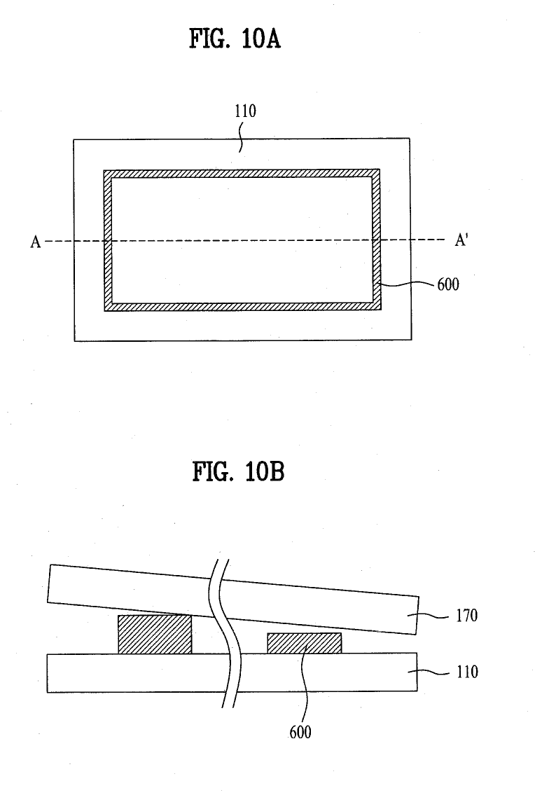

FIG. 10A is a view illustrating the process for assembling the front and back substrates of the PDP. FIG. 10B is a cross-sectional view taken along the line A-A′ of FIG. 10A.

As shown in FIGS. 10A and 10B, a sealant 600 is coated on the front substrate 170 or back substrate 110.

In detail, the sealant 600 is coated on the front substrate 170 or back substrate 110 along a region spaced apart from the periphery of the associated substrate in accordance with the printing or dispensing method.

The sealant 600 is then cured. In the curing process, organic substances contained in the sealant 600 are removed. Thus, the front substrate 170 and back substrate 110 are assembled.

Due to the curing process, the sealant 600 may have an increased width and a reduced height.

Although the sealant 600 is coated in accordance with the printing or dispensing method in this embodiment, it may be formed in the form of a sealing tape such that the sealing tape is bonded to the front substrate or back substrate.

An aging process is then carried out at a certain temperature, to achieve an enhancement in the characteristics of the passivation film, etc.

Subsequently, a front filter may be formed over the front substrate. In order to shield electromagnetic interference (EMI) waves emitted from the external of the PDP or to the PDP, the front filter is provided with an EMI shield film.

In order to shield EMI waves while securing a visible ray transmittance required in a display device, the EMI shield film may be formed by patterning a conductive material such that the conductive film has a particular pattern.

The front filter may also be formed with a near infrared ray shielding film, a color correcting film, or an anti-reflection film.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a first substrate comprising first electrodes;
a second substrate arranged to face the first substrate, the second substrate comprising second electrodes;
barrier ribs formed between the first and second substrates, to define discharge cells; and
a phosphor layer formed in each of the discharge cells,
wherein the phosphor layer comprises a phosphor and a dielectric having a secondary electron emission coefficient higher than the phosphor.

2. The plasma display panel according to claim 1, wherein the dielectric is coated on surfaces of particles of the phosphor.

3. The plasma display panel according to claim 2, wherein the phosphor has an average particle diameter of 0.1 to 5 μm, and the coating thickness of the dielectric on each particle surface of the phosphor is 1 to 10 nm.

4. The plasma display panel according to claim 1, wherein the dielectric is mixed with the phosphor in an amount of 0.1 to 50 wt % based on an amount of the phosphor.

5. The plasma display panel according to claim 4, wherein the average particle diameter of the dielectric is 0.01 to 3 μm.

6. The plasma display panel according to claim 1, wherein a discharge voltage difference among the discharge cells corresponds to 1 to 5% of a minimum discharge initiation voltage.

7. The plasma display panel according to claim 1, wherein each of the discharge cells exhibits a visible ray reflectance of 5 to 20%.

8. The plasma display panel according to claim 1, wherein the dielectric comprises at least one of oxides of Ti, Mg, La, and F, or a mixture thereof.

9. The plasma display panel according to claim 1, wherein the dielectric comprises at least one of TiO₂, MgF, and LaₓO_{y}.

10. The plasma display panel according to claim 1, wherein the phosphor comprises a material selected from a group consisting of Y(V,P)O₄:Eu or (Y,Gd)BO₃:Eu, Zn₂SiO₄:Mn, (Zn,A)₂SiO₄:Mn (“A” is an alkali metal), BaAl₁₂O₁₉:Mn, (Ba,Sr,Mg)OₐAl₂O₃:Mn (“a” is a natural number of 1 to 23), MgAlₓO_{y}:Mn (x=1 to 10, and y=1 to 30), LaMgAlₓO_{y}:Tb, Mn (x=1 to 14, and y=8 to 47), ReBO₃:Tb (“Re” is at least one rare earth element selected from a group consisting of Sc, Y, La, Ce, and Gd), BaMgAl₁₀O₁₇:Eu, CaMgSi₂O₆:Eu, CaWO₄:Pb, Y₂SiO₅:Eu, and a mixture thereof.

11. A method for manufacturing a plasma display panel, comprising:
preparing a first substrate having first electrodes and a second substrate having second electrodes;
forming barrier ribs on the second substrate, to define a plurality of discharge cells as discharge spaces;
forming phosphor layers in all or a part of the discharge cells, using a mixture of a phosphor and a dielectric having a secondary electron emission coefficient higher than the phosphor; and
assembling the first and second substrates.

12. The method according to claim 11, wherein the step of forming the phosphor layers comprises:
coating the dielectric on particles of the phosphor;
mixing a vehicle with the phosphor particles coated with the dielectric, thereby preparing a phosphor paste;
coating the phosphor paste on the discharge cells, thereby forming the phosphor layers; and
drying and curing the phosphor layers.

13. The method according to claim 12, wherein the vehicle comprises a mixture of 5 to 80 wt % of an organic binder and 10 to 95 wt % of a solvent

14. The method according to claim 12, wherein the phosphor coated with the dielectric has an average particle diameter of 0.1 to 5 μm, and the coating thickness of the dielectric is 1 to 100 nm.

15. The method according to claim 12, wherein:
the drying step is executed for 5 to 90 minutes at a temperature of 50 to 250° C.; and
the curing step is executed for 30 to 60 minutes at a temperature of 300 to 600° C.

16. The method according to claim 11, wherein the step of forming the phosphor layers comprises:
mixing the dielectric with particles of the phosphor;
mixing a vehicle with the phosphor particles mixed with the dielectric, thereby preparing a phosphor paste;
coating the phosphor paste on the discharge cells, thereby forming the phosphor layers; and
drying and curing the phosphor layers.

17. The method according to claim 16, wherein the vehicle comprises a mixture of 5 to 80 wt % of an organic binder and 10 to 95 wt % of a solvent.

18. The method according to claim 16, wherein the dielectric is mixed with the phosphor particles in an amount of 0.1 to 50 wt % based on an amount of the phosphor particles.

19. The method according to claim 16, wherein:
the average particle diameter of the dielectric is 0.01 to 3 μm; and
the phosphor particles have an average particle diameter of 0.1 to 5 μm.

20. The method according to claim 16, wherein:
the drying step is executed for 5 to 90 minutes at a temperature of 50 to 250° C.; and
the curing step is executed for 30 to 60 minutes at a temperature of 300 to 600° C.
